(19) United States
(12) Patent Application Publication
(10) Pub. No.: US 2008/0104525 A1
(43) Pub. Date: May 1, 2008

(54) Modeless Watch Window in an Iconic Programming System

(75) Inventors: Susan Germaine Wolber, Fort Collins, CO (US); Cao Luo, Beijing (CN)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 11/554,602

(22) Filed: Oct. 31, 2006

(51) Int. Cl. G06F 17/00

(52) U.S. Cl. 715/763

(57) ABSTRACT

An iconic network communicates with test and measurement instruments. A watch window displays and updates data values of the iconic network as the iconic network is processed.

### BACKGROUND OF THE INVENTION

An iconic programming system is a “programming-less” environment where programming is done by connecting graphical images of devices (icons), together with lines, to create an iconic network which represents a software program. The iconic programming system may be used in research and development test environments, where several different electronic instruments are connected to test a system or device. Programming such a system requires instructions to cause the various instruments to perform desired functions in order to operate as a system.

When an iconic programming system is used, each instrument will be represented by a graphical icon, also called a graphical object, and the connections between the instruments are represented by connecting lines between the graphical icon images. Each device may have multiple lines connecting from other devices, bringing data into the device for it to use during its execution. Each device may also have multiple output lines connecting to other devices, to pass its new or changed data on to the other devices in the program. In addition to graphical icons representing instruments in such a system, graphical icons are provided for programming functions, for example looping, IF-THEN statements, data analysis, data display, simulated instruments, etc. By combining instrument and programming icons, a user can create an iconic network involving the programmed operation of several instruments.

When the program runs, each device executes in turn, and during its execution, each device may use the data on its input lines, modify it, and put the same or other data on its output lines for other devices to use.

U.S. Pat. No. 5,377,318 to Wolber ('318 patent), which shares a common inventor with the present invention, describes a line probe function within an iconic programming system. During execution of the iconic program, the user of the system can use mouse or keyboard input to select the line probe function. When selected, the line probe stops the processing of the iconic system and displays a message asking the user to select a connecting line, an icon input terminal, or an icon output terminal. When the user selects one of these, the line probe obtains information from the object about data the object contains. The line probe then creates a dialog box on the windowing system used by the iconic programming system, displays the information along with a pushbutton, and waits for user input. The user may input data to modify the information displayed, and when the user clicks on the pushbutton, the line probe erases the dialog box and continues processing the iconic program.

The line probe function of the '318 patent is a “modal” dialog box. Here “modal” means that the user is put in a “mode” of being able to work only inside the dialogue box. The user must accept or reject a choice inside the line probe function prior to issuing any commands to the iconic application outside the line probe function and prior to continuing processing of the iconic program.

This “modal” operation is in contrast to “non-modal” or “modeless” operation wherein that the operation moves from one situation to another without apparent mode switching.

It would be desirable to be able to issue commands to the iconic application outside the line probe function while still being able to view and modify information within the dialogue box.

Various features and components of an iconic network system are disclosed in the following U.S. patent applications which are assigned to the same assignee as the present invention: U.S. Pat. No. 5,313,575, U.S. Pat. No. 5,261,043, U.S. Pat. No. 5,377,318, U.S. Pat. No. 5,293,476, U.S. Pat. No. 5,325,481, U.S. Pat. No. 5,551,041, U.S. Pat. No. 5,313,574, U.S. Pat. No. 5,437,007, U.S. Pat. No. 6,016,143, U.S. Pat. No. 5,754,426, U.S. Pat. No. 6,816,914 and U.S. Pat. No. 6,862,030.

### SUMMARY OF THE INVENTION

The present invention provides a modeless watch window in an iconic programming system which allows a user to issue commands to the iconic application outside of the watch window dialogue box while still being able to view and modify information within the dialogue box.

In more general terms the present invention is a computer implemented method for displaying data associated with icons of an iconic network in a watch window. The iconic network is formed from two or more connected icons. The iconic network and the watch window are displayed on a monitor of a computer system. The method includes the steps of: processing the iconic network; exchanging data through an instrument bus between the icons of the iconic network and external electronic instruments as the iconic network is processed; processing of the data by the icons of the iconic network; receiving user input to open the watch window within the iconic network; opening the watch window in response to the user input; displaying the processed data in the watch window; continuing the display of the processed data while processing the iconic network; and updating of the processed data in the watch window while processing the iconic network.

The present invention can also be described generally as an iconic network for communicating with test and measurement instruments comprising a watch window that displays and updates data values of the iconic network as the iconic network is processed.

The icons are connected by lines connecting input and output terminals of the icons.

The watch window is opened by processing a windowing system.

The user input is a selection of a position proximate a terminal of one of the icons using a pointing device.

The method also includes the step of querying first and second icons of the iconic network to acquire first and second icon data and displaying the first and second icon data in first and second rows of the watch window.

The first and second icon data can be a name of the first or second icons, names of terminals or names of global or local data in the iconic network.

The first and second icon data can also be data acquired by the first or second icon from external electronic instruments.

The display of the first and second icon data in the first and second rows of the watch window is updated as the iconic network is processed.

The first and second icon data can be modified by user input to display modified first and second icon data and then the iconic network can continue to be processed using the modified first and second icon data.

Also, while processing user pointer input directed outside of the watch window the processed data in the watch window can still be displayed and updated.

The iconic network sends a message to the watch window when any of the following events occur: the iconic network begins to execute, the iconic network pauses at a breakpoint, the iconic network pauses as the user steps through the iconic network, the iconic network goes into an error state, and the iconic network stops execution.

### BRIEF DESCRIPTION OF THE DRAWINGS

Further preferred features of the invention will now be described for the sake of example only with reference to the following figures, in which:

FIG. 1 shows a block diagram of a computer system incorporating the present invention.

FIG. 2 shows a portion of the iconic network processed by the computer system of FIG. 1.

FIG. 3 shows a modeless watch window along with the iconic network on the graphics display of the computer system of FIG. 1.

FIG. 4 shows the modeless watch window of FIG. 3 with a modified data value.

FIG. 5 shows the iconic network of FIG. 2 with the data input terminal of the “A+B” icon selected to bring up an input terminal information window while at the same time viewing the modeless watch window.

FIG. 6 shows an example of a modeless watch window along with a different iconic network on the graphics display of the computer system of FIG. 1.

FIG. 7 shows a flowchart for setting up the modeless watch windows of FIGS. 3 and 6 within the program flow of an iconic network.

FIG. 8 shows a flowchart setting out the processing steps for editing data in the modeless watch windows of FIGS. 3 and 6.

### DETAILED DESCRIPTION

The following description is of the best presently contemplated mode of carrying out the present invention. This description is not to be taken in a limiting sense but is made merely for the purpose of describing the general principles of the invention. The scope of the invention should be determined by referencing the appended claims.

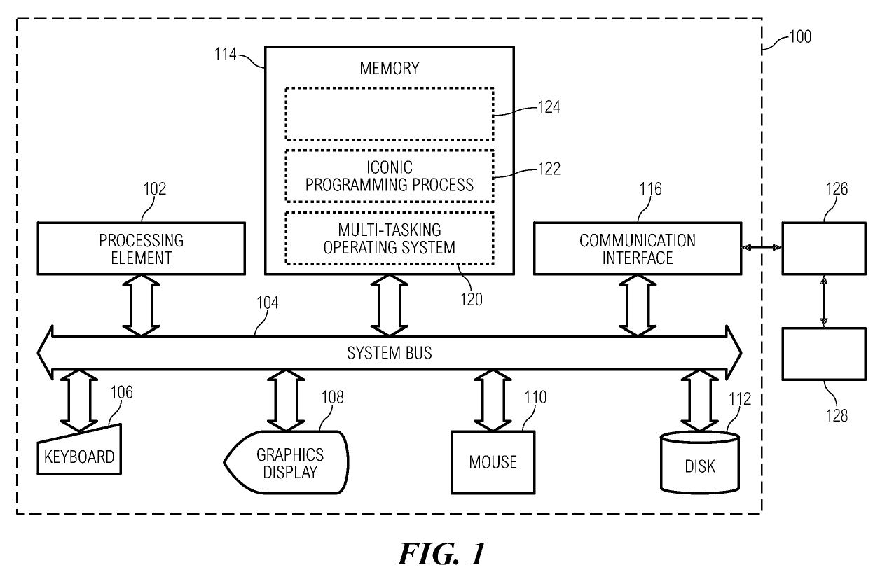

FIG. 1 shows a block diagram of a computer system incorporating the present invention. Referring now to FIG. 1, a computer system 100 contains a processing element 102 which connects to the other components of the system through a system bus 104. A keyboard 106 allows a user to input textual data to the system, and a mouse 110, or more generally any pointing device, allows a user to input graphical data to the system. A graphics display 108 allows the system to output text and graphical information to the user. A disk 112 is used by the system to store the software of the iconic programming system environment, as well as the user-defined iconic network. A communications interface 116 is used to create a communications network which allows the computer and iconic programming environment to communicate with other computers and other environments. For example, the communication thorough the communications interface 116 can be to one or more instrument 126 which can be any external test and measurement equipment, for example. Also shown is an item to be measured 128 which can be any material, device or system to be measured by the one or more instrument 126.

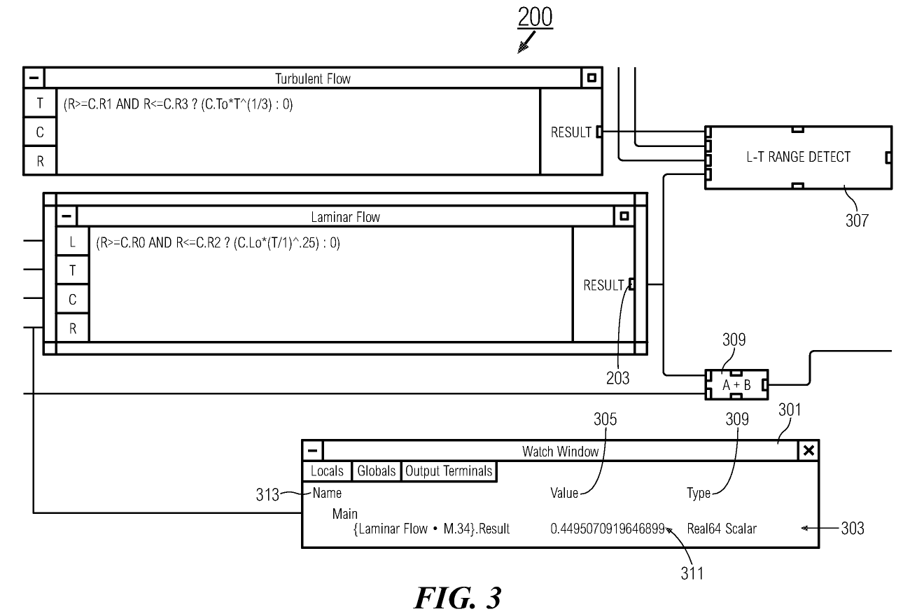

A multi-tasking operating system 120 can have a plurality of tasks, also called processes, here illustrated by task 122 and task 124. Task 122 includes the iconic programming process and the processing of a modeless watch window 301 (see FIG. 3) of the present invention. The modeless watch window 301 allows a user to issue commands to the iconic programming process outside of the watch window dialogue box while still being able to view and modify information within the dialogue box.

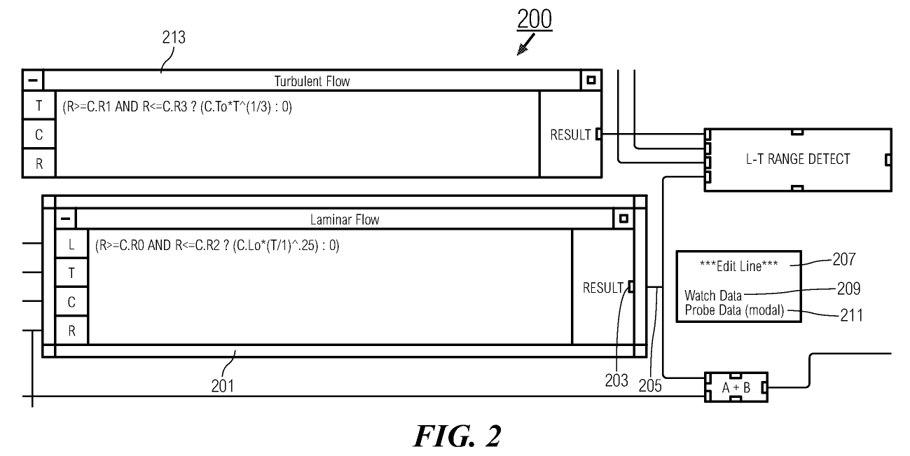

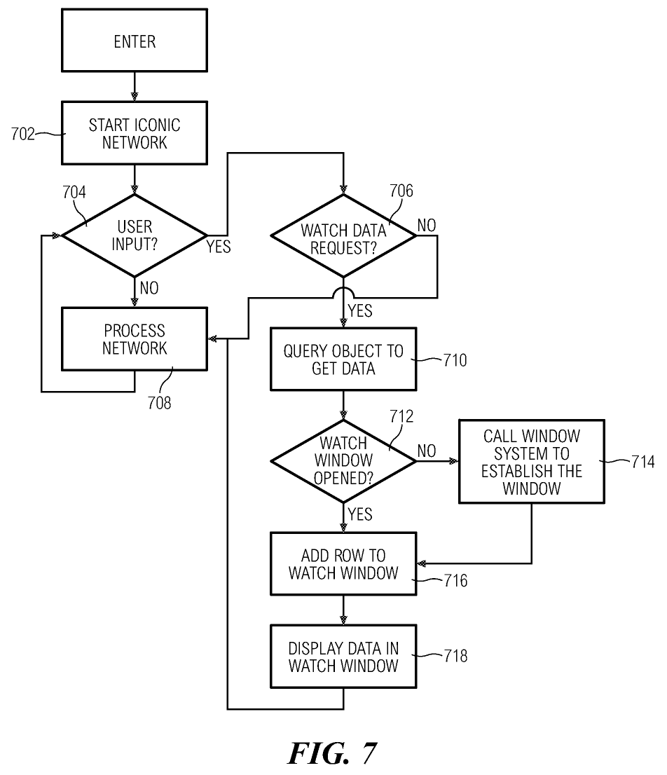

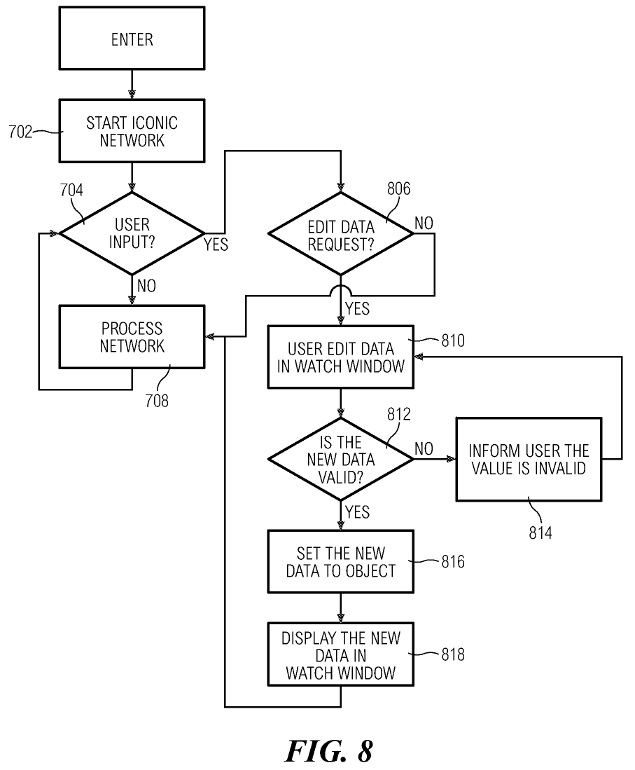

A first example of the present invention is described with reference to FIGS. 2-6. Additionally, FIG. 7 shows a flowchart for setting up the modeless watch window 301 of the present invention within the program flow of an iconic network 200 (FIG. 2). FIG. 8 shows a flowchart setting out the processing steps for editing data in the modeless watch window 301. In the flowcharts, blocks not necessary to explain the present invention are excluded but can be found in the patents mentioned in the “Background of the Invention” section above.

Turning to FIG. 2, a portion of the iconic network 200 is shown. The iconic network 200 is processed by the iconic programming process 122 and displayed on the graphics display 108 of FIG. 1. In this example, a user wants to use the iconic network 200 to calculate heat transfer coefficients of an item to be measured 128 (in this case a material). Turbulent and laminar flow is calculated by the formulas of the Turbulent Flow icon 213 and a Laminar Flow icon 201, respectively. These formulas are shown as “triadic” expressions. The formulas process data inputs representing temperature, surface type and length of surface, etc., of the material to determine the heat transfer coefficients. The instruments 126 include the actual test and measurement equipment for taking these measurements of the material. Commands and data are communicated between the graphical icons of the iconic programming process 122 and the instruments 126 through the instrument bus 116 of FIG. 1.

Returning to the flowchart of FIG. 7, when the system is started, BLOCK 702, which is an initializing or starting function, begins the processing of the iconic network 200. BLOCK 704 then determines whether any user input such as mouse input or keyboard input has occurred.

If such user input has occurred, control transfers to BLOCK 706 which determines whether the modeless watch window 301 has been requested. In the iconic network example of FIG. 2, to request the modeless watch window 301 at an output terminal 203 of a Laminar Flow icon 201, the user right clicks the mouse 110 on the output terminal 203 or the connecting line 205. Rather than using a mouse, the user can use other types of pointing devices known in the art. In response to the mouse right-click event, code of the GUI (“Graphical User Interface”) is executed which determines that the right-click occurred near the output terminal 203 or the connecting line 205. In either case, the code determines that it is the Laminar Flow icon 201 and the output terminal 203 which is of interest based on the mouse click. The GUI then creates a pop-up context menu 207. The pop-up context menu 207 allows several choices, including activating the modeless watch window 301 by selecting “Watch Data” 209, or activating a modal line probe by selecting “Probe Data (modal)” 211. The modeless watch window 301 is part of the present invention while the modal line probe is described in U.S. Pat. No. 5,377,318 which shares a common inventor with the present invention and which is assigned to the same assignee as the present invention.

If the user selects the “Watch Data” 209, then the BLOCK 706 determines that the modeless watch window 301 has been requested.

If no user input has occurred at the BLOCK 704, or if the request is not for the modeless watch window 301, control transfers to BLOCK 708 which processes part of the network and then returns the BLOCK 704. Other aspects of the network processing are not shown in order to simplify the description of the invention. This loop continues until the user requests a modeless watch window 301 at BLOCK 706, at which time control transfers from the BLOCK 706 to BLOCK 710.

BLOCK 710 also queries the icon 201 to obtain data about the particular object. In an object oriented system, such as the iconic network of the present invention, icons, lines, terminals, and other items are defined as “objects”, which have procedures and data within them. Therefore, an object can be “queried” by calling one of its procedures and asking that procedure to return data. At BLOCK 710 the code for the pop-up context menu 207 already knows that it was the output terminal 203 or the connecting line 205 that was clicked on. Code is executed which examines the output terminal 203 or the connecting line 205 to find that they are associated with the Laminar Flow icon 201 to their left. The code queries, or asks the icon 201, which can be called a first icon, for several items of information, or first icon data, which can include:

1. a user-readable name of the icon (e.g. “Laminar Flow”);

2. a unique identifier for the particular icon (e.g. “M.34”);

3. the name or unique identifier of the output terminal or the output terminal connected to the selected connecting line (e.g. “Result”);

4. the name of iconic network global data; and

5. the name of iconic network local data.

This returned data describes the information to be displayed by the modeless watch window 301.

At the time BLOCK 710 is executed for the first time, the modeless watch window 301 has still not been established. Therefore, BLOCK 712 determines that there is no watch window open and the modeless watch window needs to be established at BLOCK 714. BLOCK 714 calls a windowing system to establish a new dialog box, the modeless watch window 301. Several windowing systems exist that can be used by the present invention. For example, the X window system within the Unix operating system could be used. Unix is a registered trademark of AT&T. Microsoft Windows could also be used with the present invention. Microsoft and Windows are trademarks of Microsoft Corporation. The details of using specific windowing systems are well known to those skilled in the art. At BLOCK 716 the icon 203 object is added to the modeless watch window 301 and is indicated by a first row 303. At BLOCK 718 the data returned at BLOCK 710 is displayed at the first row 303 of the modeless watch window 301. The data is processed data which in this case is processed by the equation for laminar flow in the icon 201.

FIG. 3 shows the resulting modeless watch window 301 on the graphics display 108. The first row 303 in the modeless watch window 301 includes the data returned at BLOCK 710. The user-readable name for the icon 201 is shown in a “Name” column 313 to be “Laminar Flow”, the unique identifier for the icon 203 is shown in the “Name” column 313 to be “M.34”, and the unique identifier of the output terminal 203 is also shown in the “Name” column 313 to be “Result”. A “Value” column 305 shows a data value 311 of “0.4495 . . .”. A “Type” column 309 shows that the data value has a “Real64 Scalar” type and shape. The data value 311 is ready to be propagated to an “L-T Range Detect” icon 307 and an “A+B” icon 309. The unique identifier “M.34” is used in addition to the user-readable name for the icon 203 because the GUI might allow multiple icons to have the same user-readable name.

In general the data value 311 comes from data acquired from the external electronic instruments 126, although it can be processed in various ways by the iconic network 200.

After displaying the data at BLOCK 718, the program flow returns to BLOCK 708 and proceeds to process part of the iconic network 200.

As the iconic network 200 is processed at BLOCK 708, the iconic network 200 communicates with the modeless watch window 301 to update the data value 311 resulting in modified first icon data.

If BLOCK 710 is executed subsequently for additional objects, for example a second icon such as the “Turbulent Flow” icon 213 to obtain second icon data, then the additional object can be directly added as another row, for example a second row below the first row, of the modeless watch window 301 at BLOCK 716 and there is no need to execute BLOCK 714 again. In the present description the terms, “first row”, “second row”, or “another row”, do not imply any particular order of the rows. All that is implied is that they are separate rows. Also, any reasonable number of rows can be added to the modeless watch window 301 to represent additional icons or other objects. Similarly, the terms “first icon”, “second icon”, or “another icon” do not imply any particular ordering of the icons.

The flowchart of FIG. 8, provides a processing flow for requests to edit the data of the modeless watch window 301 after the modeless watch window 301 has been set up by the blocks of FIG. 7. BLOCKS 702, 704, 708 are the same in both FIGS. 7 and 8. However, if it is found at BLOCK 806 that the user input at BLOCK 704 is a request to edit the data of the row 303 or another row of the modeless watch window 301, then BLOCK 810 is processed which allows the user to edit data in the modeless watch window 301.

The user can use this editing feature of FIG. 8 to debug the iconic network 200. The icons in the program up through the “Laminar Flow” icon 201 are executed but the program is paused before executing the “L-T Range Detect” icon 307 and the “A+B” icon 309. Then, at BLOCK 810, the user looks at the data value 311 which is ready to be propagated from the output terminal 203 of the “Laminar Flow” icon 201 to the “L-T Range Detect” icon 307 and the “A+B” icon 309.

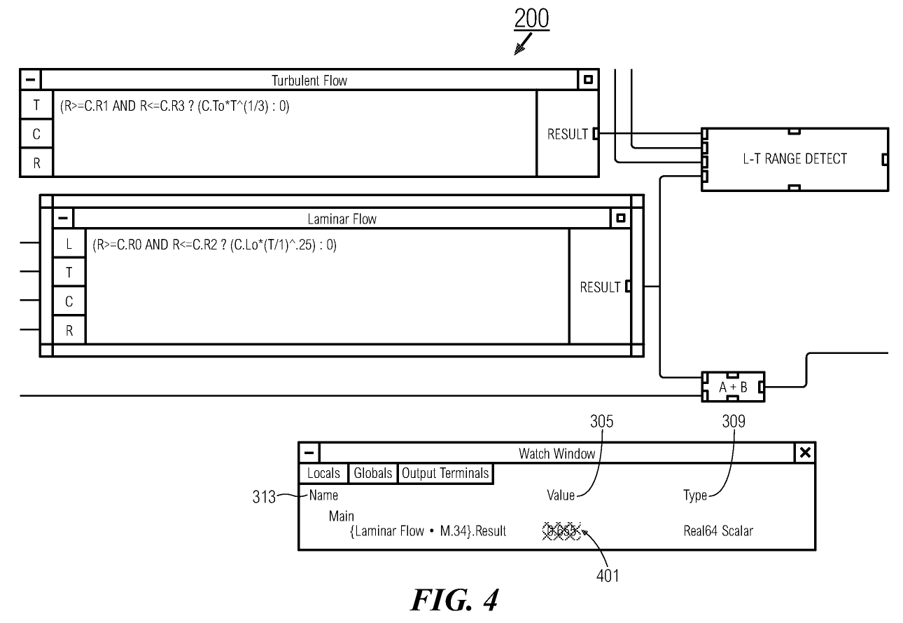

If the user decides that the formula expression in the “Laminar Flow” icon 201 is not quite right, then the user can make modifications using the modeless watch window 301, for example by modifying the data value 311 to another value such as 0.665, also at BLOCK 810. In order to modify values using the modeless watch window 301, for example the data value 311, the user can use the mouse 110 to click on the data value 311. The GUI receives the mouse click event and changes the numerical display to an editable field. The user can then type in any valid data value, for example, a modified first icon data or a modified data value 401 in FIG. 4. BLOCK 812 determines whether the modified data value 401 is a valid value and if it is not then at BLOCK 814 informs the user that the modified data value 401 is invalid and prompts the user to enter another value before returning to BLOCK 810 where the user enters another modified data value 401. Once BLOCK 812 determines that the modified data value 401 is valid the data value 401 is updated.

In BLOCK 816, the data value 311 is updated when the user enters a valid modified data value 401 into the editable field and presses return on the keyboard 106 or clicks the mouse 110 at a location outside the modeless watch window 301. The GUI then receives the mouse or keyboard event and examines the row 303 in the modeless watch window 301 that was edited. The “Name” column 313 is examined to retrieve the unique identifier “M.34” for the icon 201 and the unique identifier of the output terminal 203, “Result”.

The GUI next searches the iconic network 200 to retrieve the icon corresponding to the unique identifier “M.34” for the icon 203 and additionally retrieves the output terminal 203 identified by the unique identifier “Result” of the output terminal 203. The GUI then retrieves the modified data value 401 (“0.665”) entered by the user and uses this value to replace the old data value 311 (“0.4495 . . .”). The modified data is thus on the “Result” output terminal 203 and ready to be propagated to the rest of the iconic network 200.

BLOCK 818 is then executed so that the modified data value 401 is displayed in the modeless watch window 301.

The program returns to BLOCK 708 where the program continues with the modified data value 401. The new data value 401 of “0.665” is propagated to both the “L-T Range Detect” icon 307 and the “A+B” icon 309 and the program continues execution with the modified values.

The user can also Step the program execution (i.e. step the program one operation at a time) to propagate the modified data value 401 to the rest of the iconic network 200.

Thus the user can execute and debug the rest of the program with the modified data value 401. In many situations the program could take hours of execution to reach the “Laminar Flow” icon 201, so re-starting the program with new data can be very difficult. The present invention allows the user to pause, edit data values, and continue the program, which is extremely useful.

Prior to performing the steps for setting up the modeless watch window 301 as shown in FIG. 7 or prior to performing the steps for editing the data of the modeless watch window 301 as shown in FIG. 8, the user provides input at BLOCK 704 for pausing the program after execution of the Laminar Flow icon 201.

Alternatively or additionally, the user can put breakpoints on the “L-T Range Detect” icon 307 and the “A+B” icon 309. The insertion of these breakpoints can be one of the possible user inputs at BLOCK 704. The iconic network 200 will then automatically execute up to the icons 307, 309 and then pause.

In addition to pausing, adding breakpoints, setting up the modeless watch window 301, and editing the data of the modeless watch window 301, other GUI operations can be performed in response to a user input at BLOCK 704.

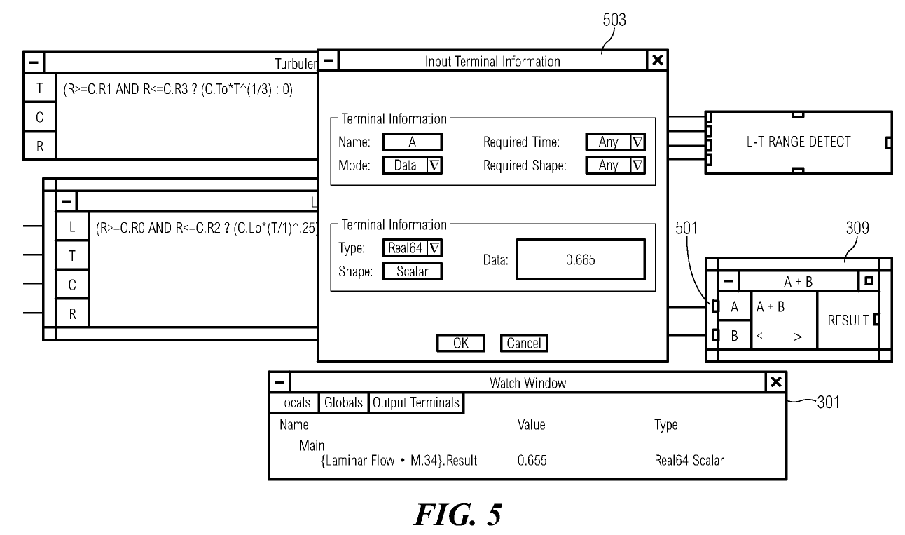

The “Probe Data (modal)” 211 function is illustrated in FIG. 5, the user can click the mouse 110 on the data input terminal 501 of the “A+B” icon 309. This will again cause the GUI to create the pop-up context menu 207. In this case the user can select the “Probe Data (modal)” 211. This will bring up the modal input terminal information window 503. In this example, the modal input terminal information window 503 allows for editing of the values for “Type” and “Shape”, which are not editable within the modeless watch window 301. The “Required Type” and “Required Shape” features are described in more detail in U.S. Pat. No. 5,261,043 which shares a common inventor with the present invention and which is assigned to the same assignee as the present invention.

FIG. 5 also serves to highlight the modeless operation of the watch window 301. The modal input terminal information window 503 is opened while the modeless watch window 301 is still up and being viewed, the user can click the mouse 110 on the data input terminal 501 of the “A+B” icon 309. The user can then look at the “A” input to verify that the icon 309 received the modified data value 401. Similarly while the modeless watch window 301 is still up and being viewed, the user can click on the “A+B” icon 309 to examine the algorithm inside of it. Again, these actions illustrate the modeless character of the watch window 301 since they are performed while still running the modeless watch window 301.

The modeless watch window 301 continues to execute concurrently with the processing of the iconic network 200. It is updated and accepts keyboard and mouse input while the iconic network 200 continues to run. As these two independent processing loops execute concurrently, they communicate between each other in several ways. The iconic network 200 sends a message to the modeless watch window 301 every time the iconic network 200 begins to run, pauses at a breakpoint, pauses as the user steps through the program, goes into an error state, or stops execution of the program. The modeless watch window 301 receives these messages from the iconic network 200 and the data displayed by the modeless watch window 301 can be updated in response. Also, despite these messages the modeless watch window 301 continues to execute.

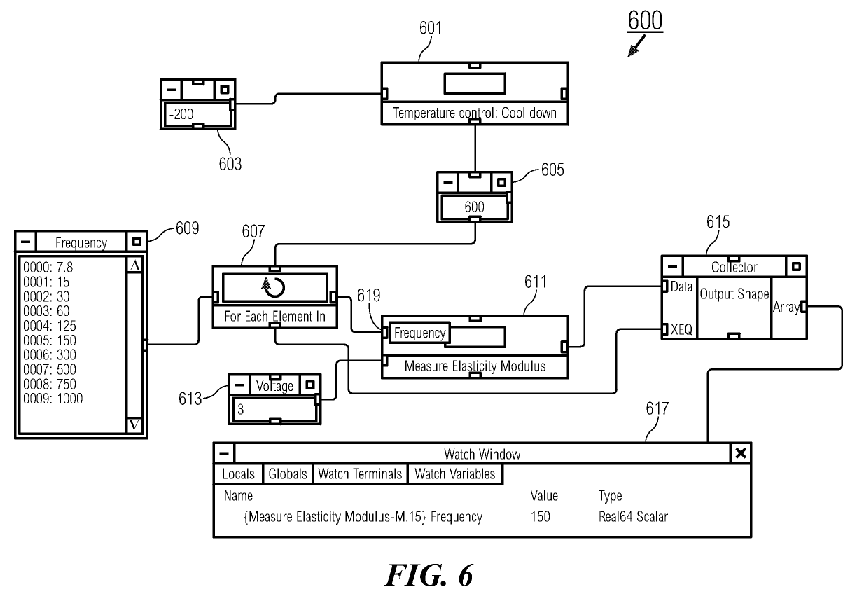

A second example of the present invention is now described with reference to FIGS. 1, 6, 7 and 8. FIG. 6 shows an iconic network 600 of the present invention which is processed by the iconic programming process 122 and displayed on the graphics display 108 of FIG. 1. The iconic network 600 includes a modeless watch window 617. The flowcharts of FIGS. 7 and 8 illustrate the method of this embodiment of the invention.

In this example a user wants to use the iconic network 600 to measure the elastic modulus of a material 128 (the elastic modulus is the slope of the stress-strain curve of the material) at a given temperature and a series of different frequencies. The instruments 126 include the actual test and measurement equipment for taking these measurements. Graphical icons represent these instruments 126. Commands and data are communicated between the graphical icons of the iconic programming process 122 and the instruments 126 through the instrument bus 116 of FIG. 1.

In the test, a temperature controller icon 601 is used to first cool the temperature of the material 128 down to −200 degrees Celsius as determined by the temperature entered into a temperature input icon 603. It can take a long time for a temperature controller controlled by the temperature controller icon to cool the material 128 to the −200 degree Celsius temperature. Therefore, in this example a delay icon 605 is inserted into the thread to delay the start of the next step of the iconic network 600. In this example, a long delay of 600 seconds is entered into the delay icon 605. Here a “thread” is defined as devices connected together. An unconnected device is also considered to be its own thread. In the particular iconic networks of the present disclosure, a thread can also be defined as objects connected through data and solid sequence lines. In contrast, objects connected only through dashed control lines, are not considered to be in a thread.

After the set delay, a loop icon 607 starts to fetch frequency values from an array of frequency values entered into a frequency icon 609. The frequency values are fetched one by one and passed to an elastic modulus measurement icon 611. A constant voltage is also provided by a voltage source 613 to the elastic modulus measurement icon 611. For each of the frequency values the elastic modulus of the material 128 is determined. A collector icon 615 collects the data of each test to an array.

However, in this example the user realizes that it is desired to acquire the result for elastic modulus at a frequency point 175 Hz rather than 150 Hz and the user would like to change the command to the instruments 126 so that this result is captured. Restarting the test would be unacceptable because the user would have to wait another 600 seconds to reach the −200 degrees Celsius temperature. The modeless watch window 617 of the present invention allows the user to change this frequency point without stopping the test.

The iconic network 600 is processed according to Blocks 702, 704 and 708 of the flowchart of FIG. 7 until user input is received. During execution of the iconic network 600, the user pauses the execution and sets a breakpoint at the elastic modulus measurement icon 611 at BLOCK 704.

BLOCKS 706, 710, 712, 714, 716, 718 are then executed to add the frequency input terminal 619 of the elastic modulus measurement icon 611 to the modeless watch window 617. When the value of the frequency input terminal 719 is 150 Hz, the user can change it to 175 Hz in the watch window 717 by executing BLOCKS 806, 810, 812, 814, 816 and 818 of the flowchart of FIG. 8. Then the user ends the pausing of the program and continues the execution of the iconic network at BLOCK 708 to obtain a result for the elastic modulus at the frequency 175 Hz.

The above examples describe dynamically changing data values of output terminals. As shown in FIGS. 3 and 6, the modeless watch windows 301, 617, in addition to having tabs for watching and modifying values at terminals, also have tabs for watching and modifying local and global variables. The local and global variable tabs can be selected and the local and global variables can thus be watched and modified in the same modeless watch window as the terminals.

An important feature of the modeless watch windows 301, 617 is that they are indeed “modeless”. This is in contrast to the line probe function of the '318 patent, referenced above, which provides a “modal” dialog box. In the modal dialog box the user must accept or reject a choice inside the line probe function prior to issuing any commands to the iconic application outside the line probe function. In other words, the “modeless” operation of the modeless watch window allows the user to move from one situation to another without apparent mode switching.

As described above with reference to BLOCK 716 of FIG. 7, the modeless watch window 301 can accept user input to “watch” additional objects. These objects can be icon inputs, icon outputs, lines and variables, for example. The modeless watch window 301 immediately displays current data for these objects. In addition, the user can edit the values of these objects at BLOCKS 810-818 of FIG. 8. The values displayed by the modeless watch window 301 also change in response to the messages received from the iconic network 200 when, for example, the iconic network 200 begins to run, pauses at a breakpoint, pauses as the user steps through the program, goes into an error state, or stops execution of the program.

The ability of the modeless watch window to show and update data values as the user Steps through the execution of the iconic network is a particularly useful enhancement to the use of the iconic network. The '318 patent does not disclose this feature. The modeless watch window allows the user to include multiple rows of data which are updated and displayed at each Step operation. A modal line probe (such as the input terminal information window 503) does not provide this feature. The modal line probe only shows the user one data value at a time and the user must manually perform several mouse clicks or other GUI selection operations to see each data value.

In the foregoing specification, the invention has been described with reference to specific exemplary embodiments thereof. The specification and drawings are, accordingly, to be regarded in an illustrative sense rather than a restrictive sense.

1. A method for displaying data in a watch window, the data associated with an icon of an iconic network within a computer system and displayed on a monitor, the method comprising the steps of:
processing the iconic network;
exchanging data through an instrument bus between icons of the iconic network and external electronic instruments as the iconic network is processed;
processing of the data by the icons of the iconic network;
receiving user input to open the watch window within the iconic network;
opening the watch window in response to the user input;
displaying the processed data in the watch window;
continuing the display of the processed data while processing the iconic network; and
updating of the processed data in the watch window while processing the iconic network.

2. The method of claim 1, wherein the icons are connected by lines connecting input and output terminals of the icons.

3. The method of claim 1, wherein the watch window is opened by processing a windowing system.

4. The method of claim 1, wherein the user input is a selection of a position proximate a terminal of one of the icons using a pointing device.

5. The method of claim 1, further comprising the steps of:
querying a first icon of the iconic network to acquire first icon data; and
displaying the first icon data in a first row of the watch window.

6. The method of claim 5, further comprising the steps of:
querying a second icon of the iconic network to acquire second icon data; and
displaying the second icon data in a second row of the watch window.

7. The method of claim 5, wherein the first icon data is a name of the first icon, a name of a terminal, a name of iconic network global data, or a name of iconic network local data.

8. The method of claim 5, wherein the first icon data is based upon data acquired by the first icon from an external electronic instrument.

9. The method of claim 5, further comprising the step of updating the display of the first icon data in the first row of the watch window as the iconic network is processed.

10. The method of claim 5, further comprising the steps of:
receiving user input to modify the first icon data to display modified first icon data; and
continuing processing of the iconic network using the modified first icon data.

11. The method of claim 1, further comprising the step of continuing the display and updating of the processed data in the watch window while continuing to process the iconic network.

12. The method of claim 1, further comprising the step of continuing the display and updating of the processed data in the watch window while processing user pointer input directed outside of the watch window.

13. The method of claim 1, wherein the iconic network sends a message to the watch window when an event occurs selected from the set comprising:
the iconic network begins to execute, the iconic network pauses at a breakpoint, the iconic network pauses as the user steps through the iconic network, the iconic network goes into an error state, and the iconic network stops execution.

14. An iconic network for communicating with test and measurement instruments comprising a watch window that displays and updates data values of the iconic network as the iconic network is processed.

15. The iconic network of claim 14, wherein the watch window displays data values from two or more icons of the iconic network.

16. The iconic network of claim 15, wherein the watch window displays separate rows each with data values from separate icons.

17. The iconic network of claim 14, wherein the iconic network sends a message to the watch window when an event occurs selected from the set comprising: the iconic network begins to execute, the iconic network pauses at a breakpoint, the iconic network pauses as the user steps through the iconic network, the iconic network goes into an error state, and the iconic network stops execution.

18. The iconic network of claim 15, wherein the watch window is open within the iconic network in response to user input.

19. The iconic network of claim 18, wherein the user input is a selection of a position proximate a terminal of one of the icons using a pointing device.
